(19) United States
(12) Patent Application Publication
(10) Pub. No.: US 2007/0126747 A1
(43) Pub. Date: Jun. 7, 2007

(54) Interleaved video frame buffer structure

(76) Inventors: Dijia Wu, Shanghai (CN); Fan Zhang, Shanghai (CN)

Correspondence Address: KACVINSKY LLC;C/O INTELLEVATE, P.O. BOX 52050, MINNEAPOLIS, MN, 55402, US

(21) Appl. No.: 11/292,985

(22) Filed: Dec. 2, 2005

(51) Int. Cl. G09G 5/36

(52) U.S. Cl. 345/545

(57) ABSTRACT

An embodiment is an interleaved video frame buffer structure that merges two separate chroma frame buffers into one chroma frame buffer by interleaving the individual chroma frame buffers. The merged chroma buffer, based on improved memory space adjacency versus two separate chroma frame buffers, may reduce the possibility of cache conflicts and improve cache utilization. Other embodiments are described and claimed.

### BACKGROUND

One international video coding standard is the H.264/MPEG-4 Advanced Video Coding (AVC) standard jointly developed and promulgated by the Video Coding Experts Group of the International Telecommunications Union (ITU) and the Motion Picture Experts Group (MPEG) of the International Organization for Standardization and the International Electrotechnical Commission. The AVC H.264/MPEG-4 AVC standard provides coding for a wide variety of applications including video telephony, video conferencing, television, streaming video, digital video authoring, and other video applications. The standard further provides coding for storage applications for the above noted video applications including hard disk and DVD storage.

### BRIEF DESCRIPTION OF THE DRAWINGS

FIG. 1 illustrates one embodiment of a media processing system

FIG. 2 illustrates one embodiment of a media processing sub-system

FIG. 3 illustrates one embodiment of a first reconstructed video frame buffer.

FIG. 4 illustrates one embodiment of a second reconstructed video frame buffer.

FIG. 5 illustrates one embodiment of a third reconstructed video frame buffer.

FIG. 6 illustrates one embodiment of a fourth reconstructed video frame buffer.

FIG. 7 illustrates one embodiment of a first logic flow.

FIG. 8 illustrates one embodiment of a second logic flow.

### DETAILED DESCRIPTION

Embodiments of an interleaved video frame buffer structure may be described. Reference may be made in detail to a description of these embodiments as illustrated in the drawings. While the embodiments may be described in connection with these drawings, there is no intent to limit them to drawings disclosed herein. On the contrary, the intent is to cover all alternatives, modifications, and equivalents within the scope of the described embodiments as defined by the accompanying claims.

In one embodiment, an interleaved video frame buffer structure that merges two separate chroma frame buffers into one chroma frame buffer by interleaving the individual chroma frame buffers. The merged chroma buffer may reduce the possibility of cache conflicts and improve cache utilization based on improved memory space adjacency versus two separate chroma frame buffers, for example. Accordingly, an encoder operating according to an embodiment may exhibit improved performance, such as increased frame rate for a given processor load or decreased processor load for a given frame rate.

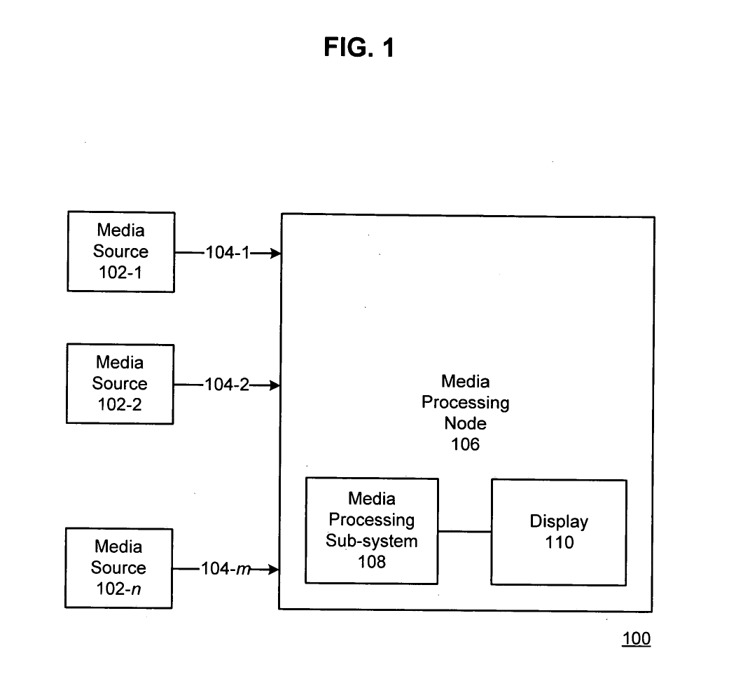

FIG. 1 illustrates one embodiment of a system. FIG. 1 illustrates a block diagram of a system 100. In one embodiment, for example, system 100 may comprise a media processing system having multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, the communications system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television System Committee (NTSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a node to process the media information in a predetermined manner, and so forth. The embodiments are not limited in this context.

In various embodiments, system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media. An example of wireless communication media may include portions of a wireless spectrum, such as the RF spectrum in general, and the ultra-high frequency (UHF) spectrum in particular. The wireless nodes may include components and interfaces suitable for communicating information signals over the designated wireless spectrum, such as one or more antennas, wireless transmitters/receivers (“transceivers”), amplifiers, filters, control logic, antennas, and so forth. The embodiments are not limited in this context.

In various embodiments, system 100 may comprise a media processing system having one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a Digital Versatile Disk (DVD) device, a Video Home System (VHS) device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (CODEC), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to vary a contrast level of an image or picture and perform other media processing operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. For example, display 110 may display the media information on a display having a VGA format resolution, XGA format resolution, SXGA format resolution, UXGA format resolution, and so forth. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

In various embodiments, media processing node 106 may be arranged to receive an input image from one or more of media source nodes 102-1-n. The input image may comprise any data or media information derived from or associated with one or more video images. In one embodiment, for example, the input image may comprise a picture in a video sequence comprising signals (e.g., Y, Cb, and Cr) sampled in both the horizontal and vertical directions. In various embodiments, the input image may comprise one or more of image data, video data, video sequences, groups of pictures, pictures, images, regions, objects, frames, slices, macroblocks, blocks, pixels, signals, and so forth. The values assigned to pixels may comprise real numbers and/or integer numbers.

In various embodiments, media processing node 106 may be arranged to receive an input video frame (including a Y frame, a Cb frame and a Cr frame) and to buffer the respective components of the video frame. More particularly, the media processing node 106 may be arranged to buffer the Y frame and to interleave and buffer the Cb frame with the Cr frame.

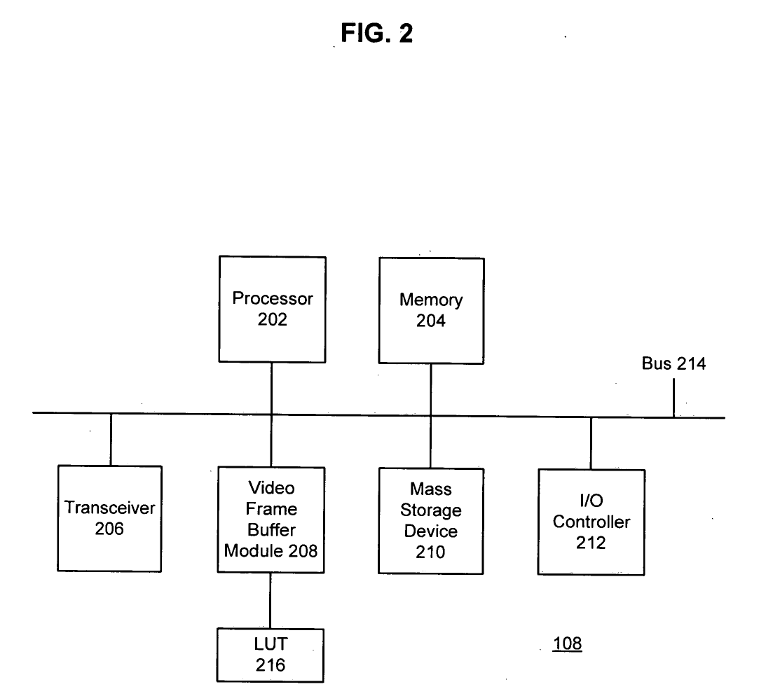

In one embodiment, for example, media processing sub-system 108 of media processing node 106 may be arranged to receive an input video frame (including a Y frame, a Cb frame and a Cr frame) and to buffer the respective components of the video frame. Media processing sub-system 108 may utilize one or more pre-defined or predetermined mathematical functions to change the buffer structure for the video frame to improve system 100 performance. System 100 in general, and media processing sub-system 108 in particular, may be described in more detail with reference to FIG. 2.

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1×RTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context. In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In one embodiment, for example, media processing sub-system 108 may include a video frame buffer module 208. Video frame buffer module 208 may be used to coordinate the buffering of a video sequence comprising Y, Cb, and Cr signals sampled in both the horizontal and vertical directions as introduced above according to predetermined mathematical functions or algorithms. For example, the predetermined mathematical functions or algorithms may be stored in any suitable storage device, such as memory 204, a mass storage device (MSD) 210, a hardware-implemented lookup table (LUT) 216, and so forth. It may be appreciated that video frame buffer module 208 may be implemented as software executed by processor 202, dedicated hardware, or a combination of both. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

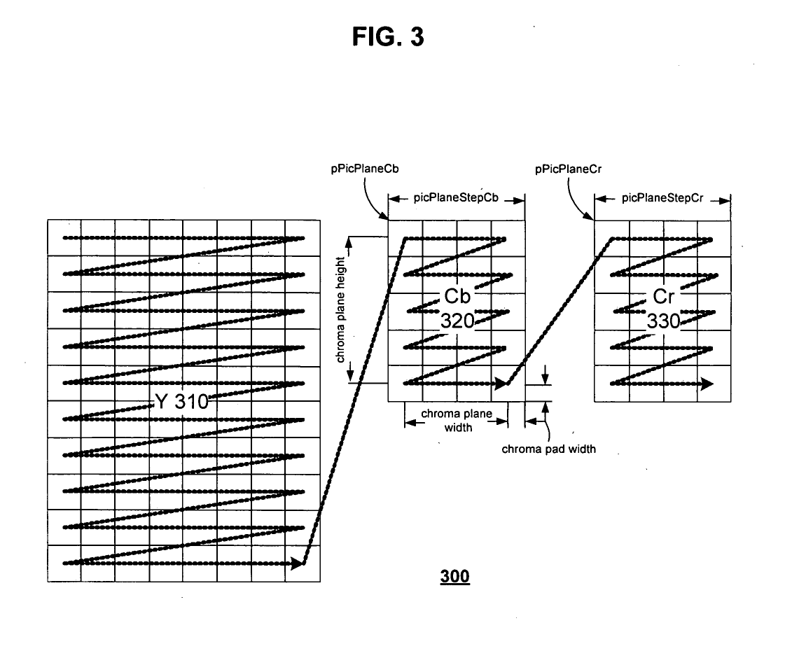

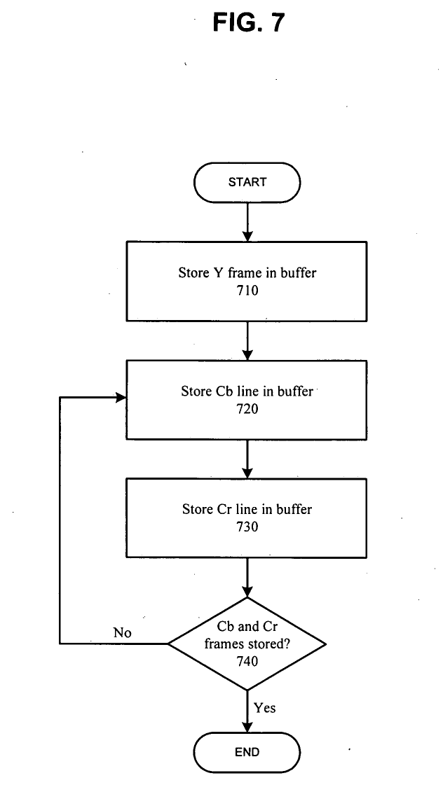

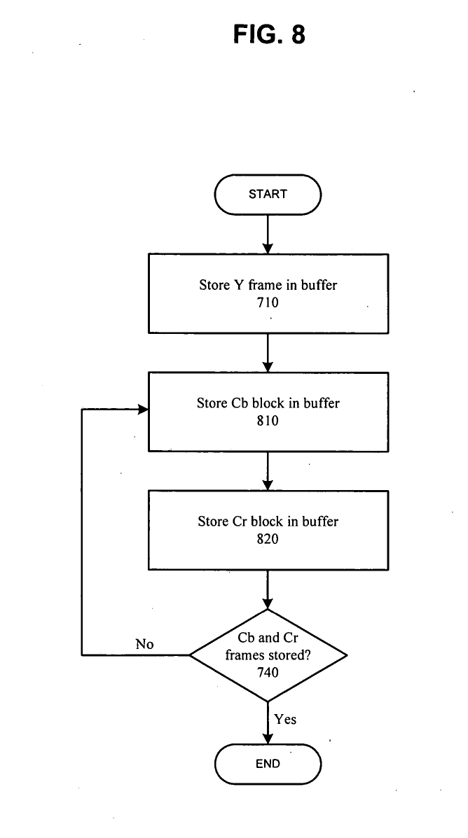

In general operation, media processing sub-system 108 may receive media information from one or more media source nodes 102-1-n. For example, media source node 102-1 may comprise a DVD device connected to processor 202. Alternatively, media source 102-2 may comprise memory 204 storing a digital AV file, such as a motion pictures expert group (MPEG) encoded AV file or a video sequence comprising Y, Cb, and Cr signals sampled in both the horizontal and vertical directions. The video frame buffer module 208 may operate to receive the media information from mass storage device 216 and/or memory 204, process the media information (e.g., via processor 202), and store or buffer the media information on memory 204, the cache memory of processor 202, or a combination thereof. The operation of the video frame buffer module 208 may be further described with reference to resulting video frame buffer structures 300-600 as described with reference to FIGS. 3-6 and the logic flows of FIGS. 7 and 8.

FIG. 3 illustrates a video frame buffer structure 300. Subsampling in a video system is usually expressed as a three part ratio, the three terms of the ratio including the number of brightness (“luma” or Y 310) samples, followed by the number of the two color samples (“chroma,” Cb 320 and Cr 330 respectively) for each complete sample area. A common sampling ratio is 4:2:0. For the 4:2:0 sampling ratio, the chroma channel that is stored flips each line (i.e., effectively the ratio is 4:2:0 for one line, 4:0:2 in the next, and so on). This leads to half the horizontal as well as half the vertical resolution resulting in the chroma sampling representing a quarter of the overall color resolution.

Each luma and chroma subsample (i.e., Y 310, Cb 320, and Cr 330) of video frame buffer structure 300 is stored as three separate memory buffers, each dedicated to its respective subsample. Further, as illustrated, Y 310, Cb 320, and Cr 330 are each stored sequentially in their entirety. For example, the Y 310 array is stored in its entirety followed by Cb 320 in its entirety and Cr 330 in its entirety.

The Y 310, Cb 320, and Cr 330 reconstructed arrays of video frame buffer structure 300 may be allocated and initialized a number of different ways. In one embodiment, reconstruction operations may be performed in accordance with the following or similar code:

```
/* pBuf : Pointer to the buffer to hold reconstructed chroma pixels
  nBufSize: Size of the buffer
  picPlaneStepCb: Stride of the Cr plane
  picPlaneStepCr: Stride of the Cr plane
  pPicPlaneCb: Pointer to the start position of Cb pixels
  pPicPlaneCr: Pointer to the start position of Cr pixels
*/
/* reconstructed frame buffer */
```

| | |
|---|---|
| int | nBufSize = (chroma_plane_width + chroma_pad_width * 2) * |
| | (chroma_plane_height + chroma_pad_width * 2); |
| void* | pBuf = NULL; |

pBuf = malloc(nBufSize * 2);
picPlaneStepCr = picPlaneStepCb = chroma_plane_width +
chroma_pad_width * 2;
pPicPlaneCb = pBuf;
pPicPlaneCr = (char*)pBuf +nBufSize.

In general, the code segment allocates a memory buffer to hold the reconstructed chroma (i.e., Cb 320 and Cr 330) pixels, sets pointers to the start of the Cb 320 and Cr 330 planes, and sets the strides of the Cb 320 and Cr 330 planes. As used herein, stride may refer to the length in bytes from the start of one Cb 320 or Cr 330 line to the start of the next Cb 320 or Cr 330 line respectively. The embodiments are not limited in this context.

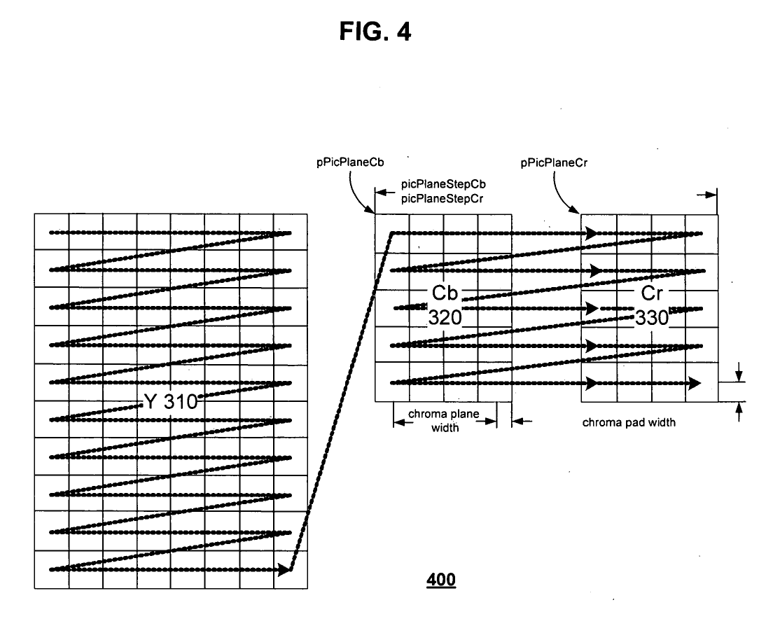

FIG. 4 illustrates the video frame buffer structure 400 of an embodiment. As noted with respect to the video frame buffer structure 300 of FIG. 3, the Cb 320 and Cr 330 blocks are separated into two distinct buffers. As the Cb 320 and Cr 330 blocks of the same position of the video frame are processed successively, however, an embodiment interleaves Cb 320 and Cr 330 line by line in a single buffer. More specifically, after the Y 310 array is stored, the first line of the Cb 320 array is stored followed by the first line of the Cr 330 array. The second lines of Cb 320 and Cr 330 are thereafter stored respectively, and so on, until the entire Cb 320 an Cr 330 arrays have been buffered.

As the Cb 320 and Cr 330 blocks of the same position on the frame are processed successively, the Cb 320 and the Cr 330 blocks of the video frame buffer structure 400 of an embodiment are closer in memory space. Alternatively, the Cb 320 and Cr 330 arrays are more compact in memory space for the video frame buffer structure 400 of an embodiment versus video frame buffer structure 300. As the Cb 320 and Cr 330 arrays are more compact in memory space for video frame buffer structure 400 versus video frame buffer structure 300, fewer cache conflicts may occur. This is because with the improved memory space adjacency, the possibility of competition for the same cache area between Cb 320 and Cr 330 pixels in one macroblock may be significantly reduced. In other words, Cb 320 and Cr 330 pixels are more likely to coexist in the data cache without any conflicts, thereby potentially improving cache utilization.

The Y 310, Cb 320, and Cr 330 reconstructed arrays of video frame buffer structure 400 may be allocated and initialized by the following or similar code, with the variables:

```
/* pBuf : Pointer to the buffer to hold reconstructed chroma pixels
  nBufSize: Size of the buffer
  picPlaneStepCb: Stride of the Cr plane
  picPlaneStepCr: Stride of the Cr plane
  pPicPlaneCb: Pointer to the start position of Cb pixels
  pPicPlaneCr: Pointer to the start position of Cr pixels
*/
/* reconstructed frame buffer */
```

| | |
|---|---|
| int | nBufSize = (chroma_plane_width + chroma_pad_width * 2) * |
| | (chroma_plane_height + chroma_pad_width * 2); |
| void* | pBuf = NULL; |

pBuf = malloc(nBufSize * 2);
picPlaneStepCr = picPlaneStepCb = (chroma_plane_width +
chroma_pad_width * 2) * 2;
pPicPlaneCb = pBuf;
pPicPlaneCr = (char*)pBuf + (chroma_plane_width +
chroma_pad_width * 2).

In particular, the strides for the Cb 320 and Cr 330 planes may be changed by a factor of two versus the strides for video frame buffer structure 300. Further, the start pointer for the Cr 330 plane has been changed. Specifically, reference to the Cr 330 plane (initially, the first line of the CR 330 plane) will start immediately after the first line of Cb 320 plane. As noted, the result is that following the storage of the entire Y 310 array or frame, the Cb 320 and Cr 330 arrays are interleaved and stored line by line. For example the first line of Cb 320 is stored followed by the fist line of Cr 330. Thereafter the second line of CB 320 is stored followed by the second line of Cr 330, and so on.

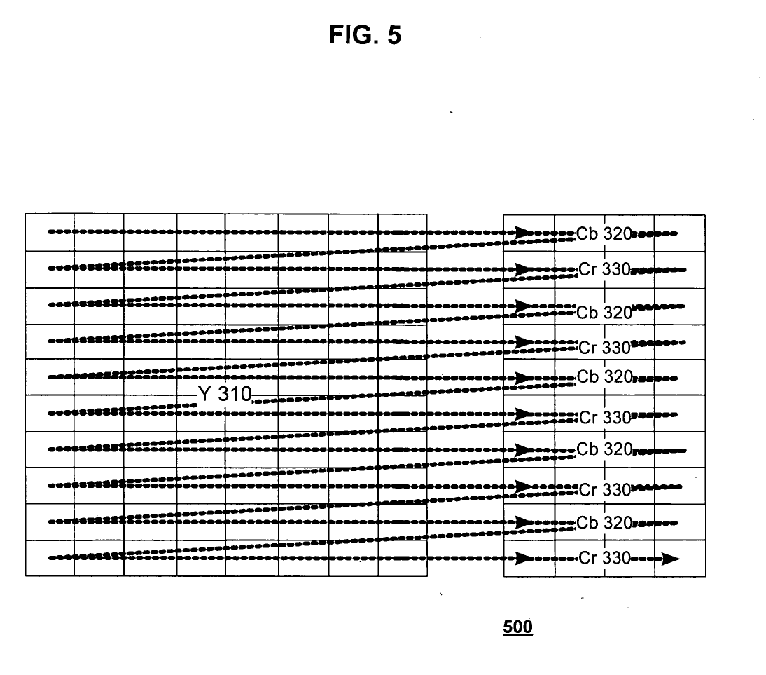

FIG. 5 illustrates video frame buffer structure 500 of embodiment that interleaves Y 310, Cb 320, Y 310, and Cr 330, line by line. For example, the first line of the Y 310 array is stored followed by the first line of the Cb 320 array. Thereafter the second Y 310 line is stored followed by the first line of the Cr 330 array. The third line of the Y 310 array is followed by the second line of the Cb 320 array and the fourth line of the Y 310 array is followed by the second line of the Cr 330 array, and so on.

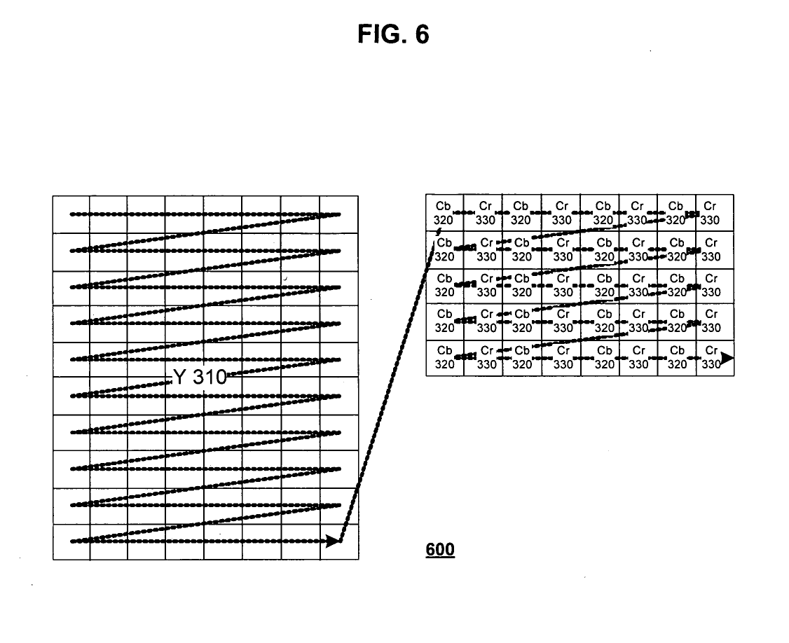

FIG. 6 illustrates video frame buffer structure 600 of embodiment that interleaves Y 310, Cb 320, and Cr 330, block by block. For example, the first block of the Y 310 array is stored, followed by the first block of the Cb 320 and the first block of the Cr 330 array respectively. Thereafter the second block of the Y 310 array is stored, followed by the second block of the Cb 320 array and the second block of the Cr 330 array respectively, and so on.

With video frame buffer structure 300 of FIG. 3 serving as a benchmark, the following Table 1 illustrates the performance difference for the several embodiments disclosed herein. As noted, the performance difference (in particular, performance gain for the embodiments of FIG. 4 and FIG. 6) can either be considered the frame rate for a given processor load or the decrease in processor load for a given frame rate. In one embodiment, for example, the performance gain of video frame buffer structure 400 is approximately 3% to 7% compared to video frame buffer structure 300 depending on test stream.

TABLE 1

| Test Stream | Picture Size | Bit Rate/Frame Rate | FIG. 4 vs. FIG. 3 | FIG. 5 vs. FIG. 3 | FIG 6 vs. FIG. 3 |
|---|---|---|---|---|---|
| Akiyo | QCIF (176 × 144) | 64 Kbps/30FPS | 2.89% | −3.21% | 1.21% |
| Foreman | QCIF (176 × 144) | 128 Kbps/30FPS | 6.45% | −4.18% | 2.35% |
| Stefan | QCIF (176 × 144) | 256 Kbps/30FPS | 5.64% | −4.66% | 2.94% |
| Akiyo | QVGA (320 × 240) | 128 Kbps/30FPS | 3.41% | −4.23% | 1.33% |
| Foreman | QVGA (320 × 240) | 256 Kbps/30FPS | 6.86% | −5.32% | 2.30% |
| Stefan | QVGA (320 × 240) | 512 Kbps/30FPS | 6.12% | −5.89% | 3.07% |

The performance increase of video frame buffer structure 400, for example, is particularly relevant to embedded mobile platforms and other applications for which memory performance is critical. Accordingly, the video frame buffer structure 400 of an embodiment will benefit, among other applications, MPEG-based, H.263-based or H.264-based software video applications on embedded mobile platforms.

FIG. 7 illustrates a flow chart of an embodiment to implement the video frame buffer structure 400 of an embodiment. At 710, the Y 310 array is stored in its entirety in a buffer. At 720, the first line of the Cb 320 array is stored in a buffer. At 730, the first line of the Cr 330 array is stored in a buffer. In an embodiment, the Cb 320 and Cr 330 elements are stored in the same buffer as to benefit from the memory space adjacency as introduced above. At 740, it is determined whether or not the Cb 320 and Cr 330 arrays have been fully stored. If no, the process returns to 720 and 730, during which another line each of Cb 320 and Cr 330 is stored respectively. The process ends when the entire Cb 320 and Cr 330 arrays have been stored line by line.

FIG. 8 illustrates a flow chart of an embodiment to implement the video frame buffer structure 600 of an embodiment. At 710, the Y 310 array is stored in its entirety in a buffer. At 810, the first block of the Cb 320 array is stored in a buffer. At 820, the first block of the Cr 330 array is stored in a buffer. In an embodiment, the Cb 320 and Cr 330 elements are stored in the same buffer as to benefit from the memory space adjacency as introduced above. At 740, it is determined whether or not the Cb 320 and Cr 330 arrays have been fully stored. If no, the process returns to 810 and 820, during which another block each of Cb 320 and Cr 330 is stored respectively. The process ends when the entire Cb 320 and Cr 330 arrays have been stored block by block.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. An apparatus comprising:
a media processing node to receive an input video frame including a Y frame, a Cb frame and a Cr frame, the media processing node to buffer the Y frame and to interleave and buffer the Cb frame with the Cr frame.

2. The apparatus of claim 1, the media processing node to include a video frame buffer module, the video frame buffer module to
buffer the Y frame;
buffer a first line of the Cb frame; and
buffer a first line of the Cr frame.

3. The apparatus of claim 2, the video frame buffer module to further
buffer a second line of the Cb frame; and
buffer a second line of the Cr frame.

4. The apparatus of claim 1, the media processing node to include a video frame buffer module, the video frame buffer module to
buffer the Y frame;
buffer a first block of the Cb frame; and
buffer a first block of the Cr frame.

5. The apparatus of claim 4, the video frame buffer to further
buffer a second block of the Cb frame; and
buffer a second block of the Cr frame.

6. A system comprising:
a communications medium; and
a media processing node to couple to the communications medium to receive an input video frame including a Y frame, a Cb frame and a Cr frame, the media processing node to buffer the Y frame and to interleave and buffer the Cb frame with the Cr frame.

7. The system of claim 6, the media processing node to include a video frame buffer module, the video frame buffer module to
buffer the Y frame;
buffer a first line of the Cb frame; and
buffer a first line of the Cr frame.

8. The system of claim 7, the video frame buffer module to further
buffer a second line of the Cb frame; and
buffer a second line of the Cr frame.

9. The system of claim 6, the media processing node to include a video frame buffer module, the video frame buffer module to
buffer the Y frame;
buffer a first block of the Cb frame; and
buffer a first block of the Cr frame.

10. The system of claim 9, the video frame buffer to further
buffer a second block of the Cb frame; and
buffer a second block of the Cr frame.

11. A method comprising:
buffering a Y frame of a video frame; and
interleaving and buffering a Cb frame and a Cr frame of the video frame.

12. The method of claim 11, interleaving and buffering the Cb frame and the Cr frame of the video frame further comprising:
buffering a first line of the Cb frame; and
buffering a first line of the Cr frame

13. The method of claim 12 further comprising:
buffering a second line of the Cb frame; and
buffering a second line of the Cr frame.

14. The method of claim 11, interleaving and buffering the Cb frame and the Cr frame of the video frame further comprising:
buffering a first block of the Cb frame; and
buffering a first block of the Cr frame

15. The method of claim 14 further comprising:
buffering a second block of the Cb frame; and
buffering a second block of the Cr frame.

16. An article comprising a machine-readable storage medium containing instructions that if executed enable a system to:
buffer a Y frame of a video frame; and
interleave and buffer a Cb frame and a Cr frame of the video frame.

17. The article of claim 16 further comprising instructions that if executed enable the system to:
buffer a first line of the Cb frame; and
buffer a first line of the Cr frame

18. The article of claim 17, further comprising instructions that if executed enable the system to:
buffer a second line of the Cb frame; and
buffer a second line of the Cr frame.

19. The article of claim 16 further comprising instructions that if executed enable the system to:
buffer a first block of the Cb frame; and
buffer a first block of the Cr frame

20. The article of claim 17, further comprising instructions that if executed enable the system to:
buffer a second block of the Cb frame; and
buffer a second block of the Cr frame.
